(19) United States
(12) Patent Application Publication
(10) Pub. No.: US 2018/0300414 A1
(43) Pub. Date: Oct. 18, 2018

(54) TECHNIQUES FOR RANKING OF SELECTED BOTS

(71) Applicant: Facebook, Inc., Menlo Park, CA (US)

(72) Inventors: Yingming Chen, Mountain View, CA (US); Jeremy Harrison Goldberg, San Francisco, CA (US); Kemal El Moujahid, Mountain View, CA (US); Yoram Talmor, Cupertino, CA (US); Chih Shao Lee, Sunnyvale, CA (US); Seyed Ahmad Anvari, Mountain View, CA (US); Michael Allen Anvari, Mountain View, CA (US); Haotian Zhang, Fremont, CA (US); Matthew Robert Anger, San Francisco, CA (US); Nicolas Andrij Bushak, San Francisco, CA (US); Salahuddin Choudhary, Palo Alto, CA (US); Christopher Bing Chen, San Francisco, CA (US)

(21) Appl. No.: 15/654,007

(22) Filed: Jul. 19, 2017

Related U.S. Application Data
(60) Provisional application No. 62/486,202, filed on Apr. 17, 2017.

(51) Int. Cl. G06F 17/30; G06Q 50/00; G06F 3/048

(52) U.S. Cl. CPC G06F 17/30867; G06F 3/048; G06F 17/30899; G06Q 50/01

(57) ABSTRACT

Techniques for ranking of selected bots are described. In one embodiment, for example, an apparatus may comprise a client front-end component operative to receive a bot contact display prompt from a client device; and send an ordered bot contact list to the client device; a bot contact list component operative to retrieve a bot contact list from a selection component, the bot contact list comprising a plurality of bot contacts; and a contact ranking component operative to determine a ranking weight for each of the plurality of bot contacts; and generate the ordered bot contact list by ordering the bot contact list based on the ranking weight. Other embodiments are described and claimed.

### RELATED APPLICATIONS

This application claims the benefit of priority under 35 U.S.C. § 119(e) to U.S. Provisional Patent Application No. 62/486,202, titled “Techniques for Ranking of Selected Bots,” attorney docket number 1360F0170Z, filed on Apr. 17, 2017, which is hereby incorporated by reference in its entirety.

This application is related to U.S. patent application Ser. No. 15/350,004, titled “Techniques for Device Configuration for Commerce Messaging Using Commerce Messaging History Information,” attorney docket number 1360F0139.1, filed on Nov. 11, 2016, which is hereby incorporated by reference in its entirety.

### BACKGROUND

Users may interact with each other in a messaging system, sending messages back and forth to each other in a text-based conversation between two or more users. A user may have a user account associated with them in the messaging system, the user account providing an online identity for the user, a destination for messages directed to the user, and generally coordinating the user's access to and use of the messaging system. A user may access the messaging system from a variety of endpoints, including mobile devices (e.g., cellphones), desktop computers, web browsers, specialized messaging clients, etc.

### SUMMARY

The following presents a simplified summary in order to provide a basic understanding of some novel embodiments described herein. This summary is not an extensive overview, and it is not intended to identify key/critical elements or to delineate the scope thereof. Some concepts are presented in a simplified form as a prelude to the more detailed description that is presented later.

Various embodiments are generally directed to techniques for ranking of selected bots. Some embodiments are particularly directed to techniques for ranking of selected bots based on bot-specific information, social-context information, and bot-specific search-result performance information. In one embodiment, for example, an apparatus may comprise a client front-end component operative to receive a bot contact display prompt from a client device; and send an ordered bot contact list to the client device; a bot contact list component operative to retrieve a bot contact list from a selection component, the bot contact list comprising a plurality of bot contacts; and a contact ranking component operative to determine a ranking weight for each of the plurality of bot contacts; and generate the ordered bot contact list by ordering the bot contact list based on the ranking weight. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a bot search system.

FIG. 2 illustrates an embodiment of a social graph.

FIG. 3A illustrates an embodiment of a user interface for search results.

FIG. 3B illustrates an embodiment of a user interface for bot discovery with an all categories vertical scrolling list.

FIG. 3C illustrates an embodiment of a user interface for bot discovery with a horizontal pane and a vertical pane.

FIG. 4 illustrates an embodiment of a bot search system performing a bot search.

FIG. 5 illustrates an embodiment of a logic flow for the system of FIG. 1.

FIG. 6 illustrates an embodiment of a centralized system for the system of FIG. 1.

FIG. 7 illustrates an embodiment of a distributed system for the system of FIG. 1.

FIG. 8 illustrates an embodiment of a computing architecture.

FIG. 9 illustrates an embodiment of a communications architecture.

FIG. 10 illustrates an embodiment of a radio device architecture.

### DETAILED DESCRIPTION

Users may engage with a business via a page in a social networking service using messaging communication, as they may be familiar with from chatting with friends. Users may discover, engage with, and purchase products and services from these businesses in the same messaging application they use for communicating with friends, colleagues, and other acquaintances.

Users may be accustomed to interacting with a business via a web page. Even where this web page contains interactive or dynamic elements, the interaction is still received in the presentation style of a web page. Business pages, similar to web pages, may be accessible via a messaging system. However, where a web page may empower chatting via a pop-up dialog box, a messaging system may display a conversational interaction with a business in a messaging-specific interface. This may serve to ground the interaction in the presentation style of messaging, thereby humanizing and personalizing the experience. Further, as with messaging with another person, the messaging client may maintain a history of a conversation, allow navigation away from the conversation and returning, and a mirroring of the conversation across multiple user devices. In contrast, a pop-up messaging dialog on a web page is temporary, stuck to a browser window that cannot be closed until the conversation is completed, and rooted in a single user device. This conversation with a business page may be represented by a bot, the bot a virtual representation of the business page in a messaging environment. The bot may function as an avatar for the business and unify the experience of messaging with a business within a single messaging representation.

Bots may also be used for the one-way delivery of information. Bots may provide news, media, and other content to users delivered through a messaging system. Users may subscribe to a bot for a business and receive real-time messages from the bot in their messaging client.

Users may be suggested businesses with which to engage with. In some cases, these suggestions may be made as search results to a user search. A user may enter search information and have that search information used to produce search results, which may include bots suggested for them to interact with. In some cases, these suggestions may be made separately from a search. For example, a null state for a search page—a search page into which search information has not been entered—may include suggestions prior to search terms being entered. Suggested bots may generally be presented in any form of interface.

Users may be provided with a directory interface empowering them to browse available bots. These users may be able to depend on such a directory interface to browse available messaging experiences. Further, developers are aided by promoting and showcasing the experiences their bots offer through the directory interface. Developers are empowered to label and categorize their bots' experiences via a taxonomy to improve discovery and search. Developers are empowered to specify how their bots should be labeled and categorized so as to provide them with control over how users discover their bot and are primed to interact with their bot. The bot system provider, such as a messaging system provider, may benefit from increased developer and user activity, improving the bot ecosystem. In addition, the bot system provider may be able to leverage paid promotion to support the operations of the bot system.

It will be appreciated that the techniques described herein may be used in any system where users are suggested bots with which to engage using a communication system, such as a messaging system, email system, voice communication system, video communication system, or any other communication system. The techniques described herein with regards to bots in a messaging system may be used in any embodiment in which a plurality of bots are promoted to a user.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

It is worthy to note that “a” and “b” and “c” and similar designators as used herein are intended to be variables representing any positive integer. Thus, for example, if an implementation sets a value for a=5, then a complete set of components 122 illustrated as components 122-1 through 122-a may include components 122-1, 122-2, 122-3, 122-4 and 122-5. The embodiments are not limited in this context.

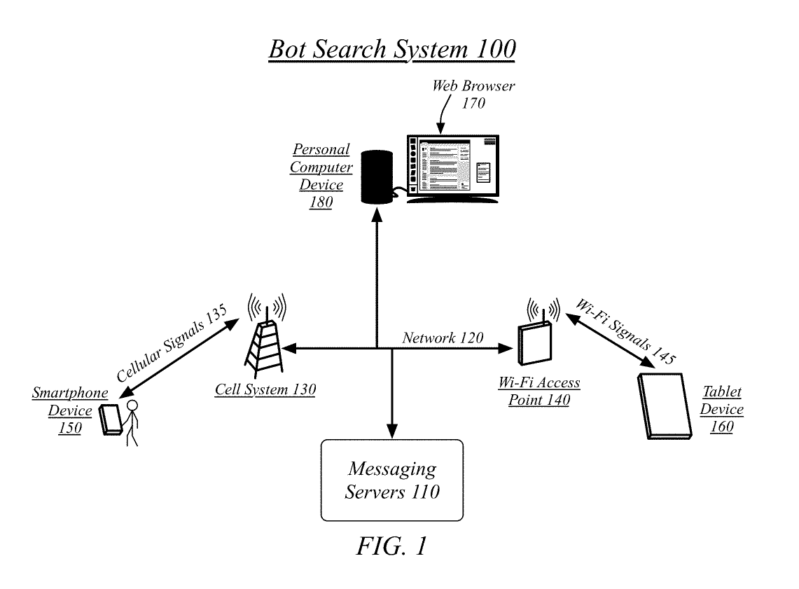

FIG. 1 illustrates a block diagram for a bot search system 100. In one embodiment, the bot search system 100 may comprise a computer-implemented system having software applications comprising one or more components. Although the bot search system 100 shown in FIG. 1 has a limited number of elements in a certain topology, it may be appreciated that the bot search system 100 may include more or less elements in alternate topologies as desired for a given implementation.

Messaging servers 110 may comprise one or more messaging servers operated by a messaging platform as part of a messaging system. A messaging server may comprise an Internet-accessible server, with the network 120 connecting the various devices of the messaging system comprising, at least in part, the Internet. A messaging system may use the messaging servers 110 to support messaging for various user client devices.

A user may own and operate a smartphone device 150. The smartphone device 150 may comprise an iPhone® device, an Android® device, a Blackberry® device, or any other mobile computing device conforming to a smartphone form. The smartphone device 150 may be a cellular device capable of connecting to a network 120 via a cell system 130 using cellular signals 135. In some embodiments and in some cases the smartphone device 150 may additionally or alternatively use Wi-Fi or other networking technologies to connect to the network 120. The smartphone device 150 may execute a messaging client, web browser, or other local application to access the messaging servers 110.

The same user may own and operate a tablet device 160. The tablet device 150 may comprise an iPad® device, an Android® tablet device, a Kindle Fire® device, or any other mobile computing device conforming to a tablet form. The tablet device 160 may be a Wi-Fi device capable of connecting to a network 120 via a Wi-Fi access point 140 using Wi-Fi signals 145. In some embodiments and in some cases the tablet device 160 may additionally or alternatively use cellular or other networking technologies to connect to the network 120. The tablet device 160 may execute a messaging client, web browser, or other local application to access the messaging servers 110.

The same user may own and operate a personal computer device 180. The personal computer device 180 may comprise a Mac OS® device, Windows® device, Linux® device, or other computer device running another operating system. The personal computer device 180 may be an Ethernet device capable of connecting to a network 120 via an Ethernet connection. In some embodiments and in some cases the personal computer device 180 may additionally or alternatively use cellular, Wi-Fi, or other networking technologies to the network 120. The personal computer device 180 may execute a messaging client, web browser 170, or other local application to access the messaging servers 110.

A messaging client may be a dedicated messaging client. A dedicated messaging client may be specifically associated with a messaging provider administering the messaging platform including the messaging servers 110. A dedicated messaging client may be a general client operative to work with a plurality of different messaging providers including the messaging provider administering the messaging platform including the messaging servers 110.

The messaging client may be a component of an application providing additional functionality. For example, a social networking service may provide a social networking application for use on a mobile device for accessing and using the social networking service. The social networking service may include messaging functionality such as may be provided by messaging servers 110. It will be appreciated that the messaging servers 110 may be one component of a computing device for the social networking service, with the computing device providing additional functionality of the social networking service. Similarly, the social networking application may provide both messaging functionality and additional social networking functionality.

In some cases a messaging endpoint may retain state between user sessions and in some cases a messaging endpoint may relinquish state between user session. A messaging endpoint may use a local store to retain the current state of a message inbox. This local store may be saved in persistent storage such that the state may be retrieved between one session and the next, including situations in which, for example, a local application is quit or otherwise removed from memory or a device is powered off and on again. Alternatively, a messaging endpoint may use a memory cache to retain the current state of a message inbox but refrain from committing the state of the message inbox to persistent storage.

A messaging endpoint that retains the state of a message inbox may comprise a dedicated messaging application or a messaging utility integrated into another local application, such as a social networking application. A messaging endpoint that relinquishes state of a message inbox may comprise messaging access implemented within a web browser. In one embodiment, a web browser, such as web browser 170 executing on personal computer device 180, may execute HTML5 code that interacts with the messaging server to present messaging functionality to a user.

A user may send and receive messages from a plurality of devices, including the smartphone device 150, tablet device 160, and personal computer device 180. The user may use a first messaging application on the smartphone device 150, a second messaging application on the tablet device 160, and the web browser 170 on the personal computer device 180. The first and second messaging applications may comprise installations of the same application on both devices. The first and second messaging applications may comprise a smartphone-specific and a tablet-specific version of a common application. The first and second messaging application may comprise distinct applications.

The user may benefit from having their message inbox kept consistent between their devices. A user may use their smartphone device 150 on the cell system 130 while away from their home, sending and receiving messages via the cells system 130. The user may stop by a coffee shop, or other location offering Wi-Fi, and connect their tablet device 160 to a Wi-Fi access point 140. The tablet device 160 may retrieve its existing known state for the message inbox and receive updates that have happened since the last occasion on which the tablet device 160 had access to a network, including any messages sent by the smartphone device 150 and that may have been received by the user while operating the smartphone device 150. The user may then return home and access their message inbox using a web browser 170 on a personal computer device 180. The web browser 170 may receive a snapshot of the current state of the message inbox from the messaging servers 110 due to it not maintaining or otherwise not having access to an existing state for the message inbox. The web browser 170 may then retrieve incremental updates for any new changes to the state of the message inbox so long as it maintains a user session with the messaging servers 110, discarding its known state for the message inbox at the end of the session, such as when the web browser 170 is closed by the user. Without limitation, an update may correspond to the addition of a message to a mailbox, a deletion of a message from a mailbox, and a read receipt.

A messaging system may operate by defining a messaging inbox as comprising a plurality of messages, wherein each message is an individual transaction of communication between two or more participants. A mail server may operate by maintaining a message index for the messaging inbox. Mail servers may receive messages and store the messages in mail archives from which messages may be retrieved through reference to the message index. Mail clients may connect to the mail servers and retrieve messages that have been added to their mail archive since their last update. The mail clients may receive a mail index from the mail archive indicating what messages are stored in the mail archive. The mail clients may compare the mail archive to their current inbox in order to determine what messages they are missing, which they then request from the mail archive. The mail clients may make changes to their inbox, which results in mail inbox instructions being transmitted to the mail archives instructing the mail archives in modifications to make to the representation of their mail inbox on the mail archives.

Messaging interactions mediated by a messaging system may be organized into shared spaces known as message threads. A message thread may collect together the messages shared between a particular group of users. Messages sent individually between a pair of users may be collected into a one-on-one message thread uniquely associated with the private messaging between the pair of users. Messages sent between a group of three or more users may not be uniquely defined by their membership, but instead by, in some embodiments, an identifier uniquely identifying the group thread. Membership in a group thread may, in some embodiments, vary over time, adding and/or losing members.

The messaging system may use knowledge generated from interactions in between users. The messaging system may comprise a component of a social-networking system and may use knowledge generated from the broader interactions of the social-networking system. As such, to protect the privacy of the users of the messaging system and the larger social-networking system, messaging system may include an authorization server (or other suitable component(s)) that allows users to opt in to or opt out of having their actions logged by the messaging system or shared with other systems (e.g., third-party systems), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers or other authorization components may be used to enforce one or more privacy settings of the users of the messaging system and other elements of a social-networking system through blocking, data hashing, anonymization, or other suitable techniques as appropriate.

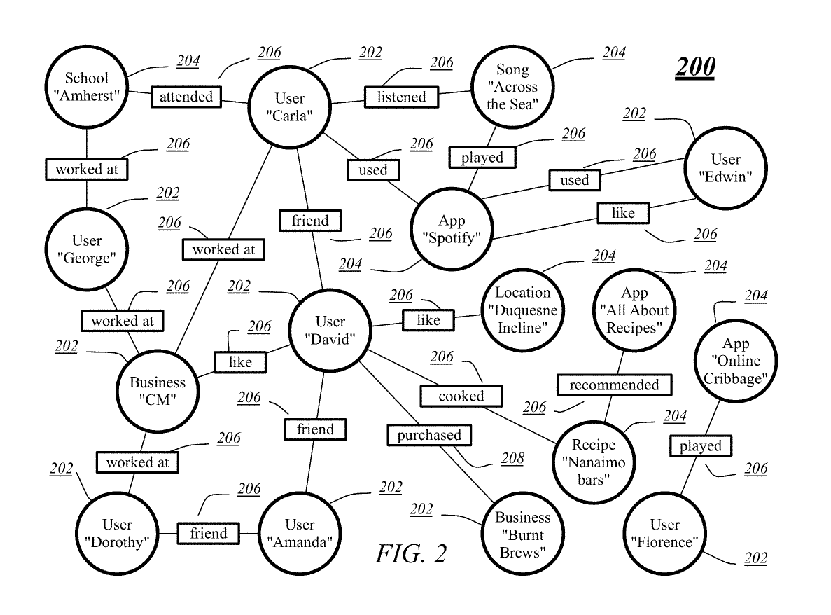

FIG. 2 illustrates an example of a social graph 200. In particular embodiments, a social-networking system may store one or more social graphs 200 in one or more data stores as a social graph data structure.

In particular embodiments, social graph 200 may include multiple nodes, which may include multiple user nodes 202 and multiple concept nodes 204. Social graph 200 may include multiple edges 206 connecting the nodes. In particular embodiments, a social-networking system, client system, third-party system, or any other system or device may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of the social-networking system. As an example and not by way of limitation, a user may be an individual (human user), an entity (e.g., an enterprise, business, or third-party application), or a group (e.g., of individuals or entities) that interacts or communicates with or over the social-networking system. In particular embodiments, when a user registers for an account with the social-networking system, the social-networking system may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system. In particular embodiments, a user node 202 may be associated with information provided by a user or information gathered by various systems, including the social-networking system. As an example and not by way of limitation, a user may provide their name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages. A user node 202 may be associated with a unique user identifier for the user in the social-networking system.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-network service or a third-party website associated with a web-application server); an entity (such as, for example, a person, business, group, sports team, or celebrity); a resource (such as, for example, an audio file, video file, digital photo, text file, structured document, or application) which may be located within the social-networking system or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking system. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to the social-networking system. Profile pages may also be hosted on third-party websites associated with a third-party server. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. A business page may comprise a user-profile page for a commerce entity. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system to send to the social-networking system a message indicating the user's action. In response to the message, the social-networking system may create an edge (e.g., an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system may send a “friend request” to the second user. If the second user confirms the “friend request,” the social-networking system may create an edge 206 connecting the first user's user node 202 to the second user's user node 202 in social graph 200 and store edge 206 as social-graph information in one or more data stores. In the example of FIG. 2, social graph 200 includes an edge 206 indicating a friend relation between user nodes 202 of user “Amanda” and user “Dorothy.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, the social-networking system may create a “favorite” edge or a “check in” edge in response to a user's action corresponding to a respective action. As another example and not by way of limitation, a user (user “Carla”) may listen to a particular song (“Across the Sea”) using a particular application (SPOTIFY, which is an online music application). In this case, the social-networking system may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking system may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Across the Sea”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “Edwin” and concept node 204 for “SPOTIFY”).

In particular embodiments, the social-networking system may create an edge 206 between a user node 202 and a concept node 204 in social graph 200. As an example and not by way of limitation, a user viewing a concept-profile page (such as, for example, by using a web browser or a special-purpose application hosted by the user's client system) may indicate that he or she likes the concept represented by the concept node 204 by clicking or selecting a “Like” icon, which may cause the user's client system to send to the social-networking system a message indicating the user's liking of the concept associated with the concept-profile page. In response to the message, the social-networking system may create an edge 206 between user node 202 associated with the user and concept node 204, as illustrated by “like” edge 206 between the user and concept node 204. In particular embodiments, the social-networking system may store an edge 206 in one or more data stores. In particular embodiments, an edge 206 may be automatically formed by the social-networking system in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

The social graph 200 may further comprise a plurality of product nodes. Product nodes may represent particular products that may be associated with a particular business. A business may provide a product catalog to a consumer-to-business service and the consumer-to-business service may therefore represent each of the products within the product in the social graph 200 with each product being in a distinct product node. A product node may comprise information relating to the product, such as pricing information, descriptive information, manufacturer information, availability information, and other relevant information. For example, each of the items on a menu for a restaurant may be represented within the social graph 200 with a product node describing each of the items. A product node may be linked by an edge to the business providing the product. Where multiple businesses provide a product, each business may have a distinct product node associated with its providing of the product or may each link to the same product node. A product node may be linked by an edge to each user that has purchased, rated, owns, recommended, or viewed the product, with the edge describing the nature of the relationship (e.g., purchased, rated, owns, recommended, viewed, or other relationship). Each of the product nodes may be associated with a graph id and an associated merchant id by virtue of the linked merchant business. Products available from a business may therefore be communicated to a user by retrieving the available product nodes linked to the user node for the business within the social graph 200. The information for a product node may be manipulated by the social-networking system as a product object that encapsulates information regarding the referenced product.

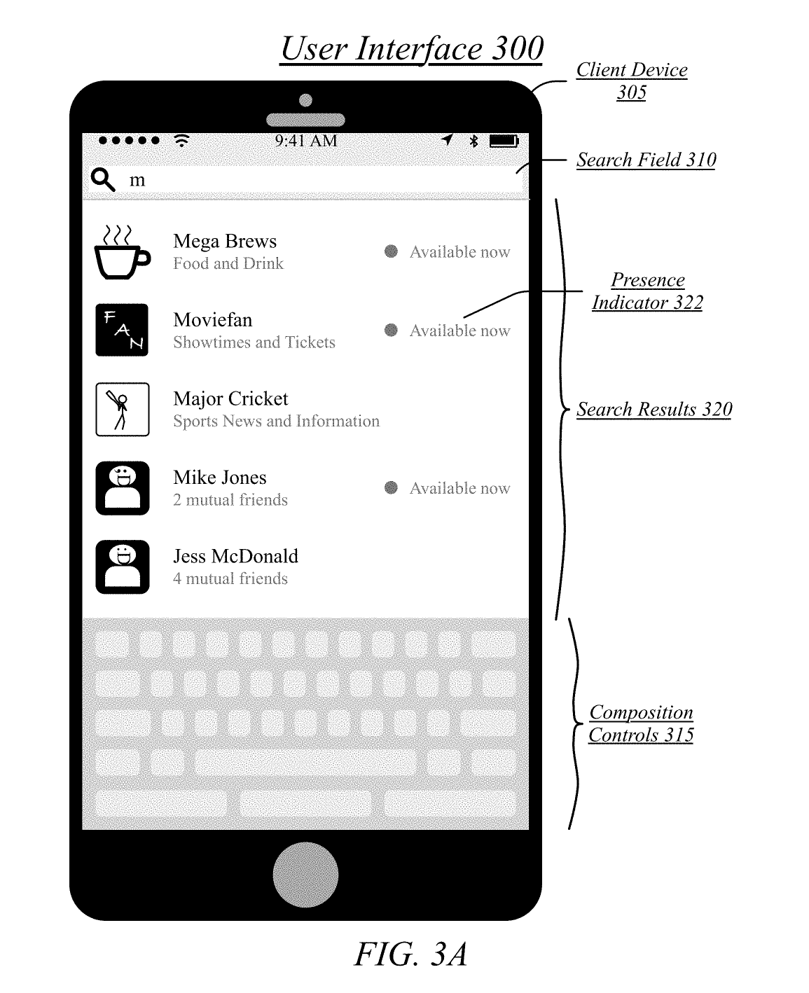

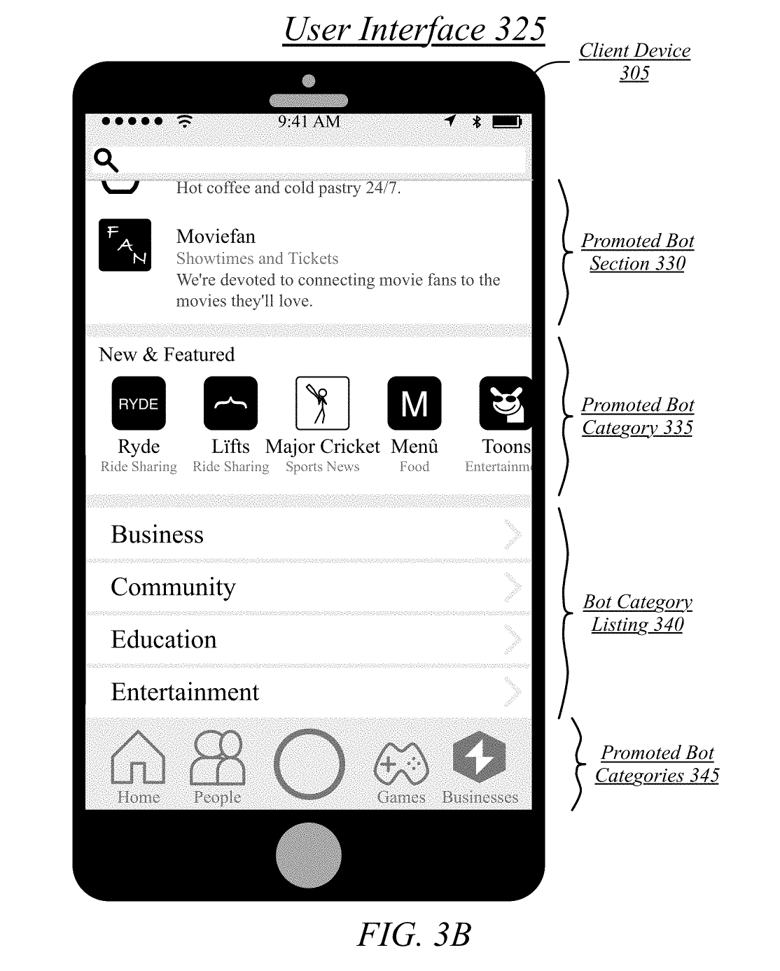

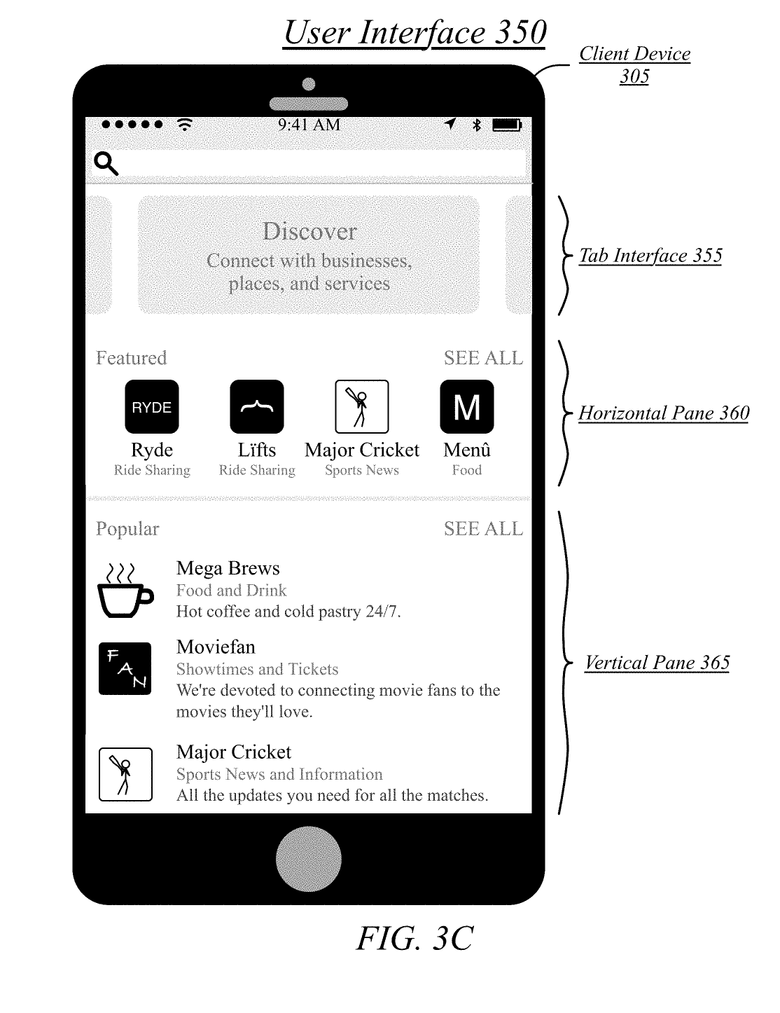

FIG. 3A illustrates an embodiment of a user interface 300 for search results 320.

A search interface may comprise a search field 310, which may comprise a complete or partial entry of text. The search results 320 may be updated as additional text is entered in the search field 310. For instance, composition controls 315 may be used to enter text into the search 310. Many, most, or nearly all of the composition controls 310 may empower access to further user interface controls for the performance of various tasks, such as text entry, media selection, emoji selection, camera use, a social approval icon, etc.

The search results 320 may comprise matches to the text of the search field 310. The search results 320 may comprise suggested results based on the text of the search field 310, which may be ranked and displayed in order by the bot search system 100. As illustrated, the search results 320 may include a plurality of different types of contacts. Search results 310 may include personal contacts (e.g., friends or previous individual messaging partners), groups (e.g., previous or otherwise available group conversation), and/or businesses as represented by bots. Alternatively, in some embodiments, a search interface may be provided that is exclusive to bots in which all search results 320 will be bots. In some embodiments, a set of null-state suggestions may be displayed when no search information has been provided, such as where no text has been entered in a search field 310. These null-state suggestions may be replaced with search results 320 once search information has been provided.

Search results 320 may include information about one or more of the results. Included information may comprise one or more of a number of mutual friends for a contact, a product or service area for a messaging bot, and an indication of whether a personal or bot search result is currently present on the messaging system and available for messaging. For instance, an presence indicator 322 may be displayed in association with all those and only those contacts that are currently present on the messaging system and potentially available to be messed with. The bot search system 100 may determine presence according to a variety of techniques, such as whether the bot search system 100 currently has network connectivity to a client device associated with the contact.

FIG. 3B illustrates an embodiment of a user interface 325 for bot discovery with an all-categories vertical-scrolling bot category listing 340.

A user interface 325 for bot discovery may include a promoted bots section 330. The promoted bots section 330 comprises bots selected for promotion to the user. The promoted bots section 330 may include bots that user has used before, bots associated with businesses that the user has a relationship with, local bots, or bots otherwise selected for promotion.

The user interface 325 for bot discovery may include a promoted bot category 335. The promoted bot category 335 may be a particular category from a plurality of categories available to a user. The promoted bot category 335 may be displayed as a horizontally scrollable area.

The user interface 325 for bot discovery may include a bot category listing 340. A bot category listing 340 may comprise a comprehensive listing of all of the bot categories available to the user. The bot category listing 340 may comprise a vertical scrolling list. Selecting a category entry on the bot category listing 340 opens a view of bots within that category.

The user 325 for bot discovery may include a quick-access area with a group of promoted bot categories 345. The quick-access area may be persistent on the screen despite the screen being scrolled, with a set screen position independent of interface scrolling. The quick-access area may be configured with a particular set of categories being promoted to users of the messaging system. The promoted bot categories 345 may be configured uniformly for all users of the messaging system. Alternatively, the promoted bot categories may be configured individually for the user of the client device 305.

FIG. 3C illustrates an embodiment of a user interface 350 for bot discovery with a horizontal pane 360 and a vertical pane 365.

A user interface 350 for a messaging client may include a tab interface 355. The tab interface 355. The tab interface 355 may empower users to select from among areas of functionality for the messaging client. The tab interface 355 may include a discovery tab empowering a user to access the discovery interface for the messaging client. The tab interface 355 may include tabs for other areas of functionality, such as user-to-user messaging.

The user interface 350 may include a horizontal pane 360. A horizontal pane 360 is a horizontally-aligned display of bots which is horizontally scrollable by the user. The entries in the horizontally-aligned display are aligned along a horizontal extent of the user interface 350. A horizontal pane 360 may include a pane title indicated a category of bots in the horizontal pane 360. A horizontal pane 360 may include a category selection control. The category selection control empowers access to a dedicated display of bots within the category associated with the horizontal pane 360.

The user interface 350 may include a vertical pane 365. A vertical pane 365 is a vertically-aligned display of bots which is vertically scrollable by the user. The entries in the vertically-aligned display are aligned along a vertical extent of the user interface 350. A vertical pane 365 may include a pane title indicated a category of bots in the vertical pane 365. A vertical pane 365 may include a category selection control. The category selection control empowers access to a dedicated display of bots within the category associated with the vertical pane 365.

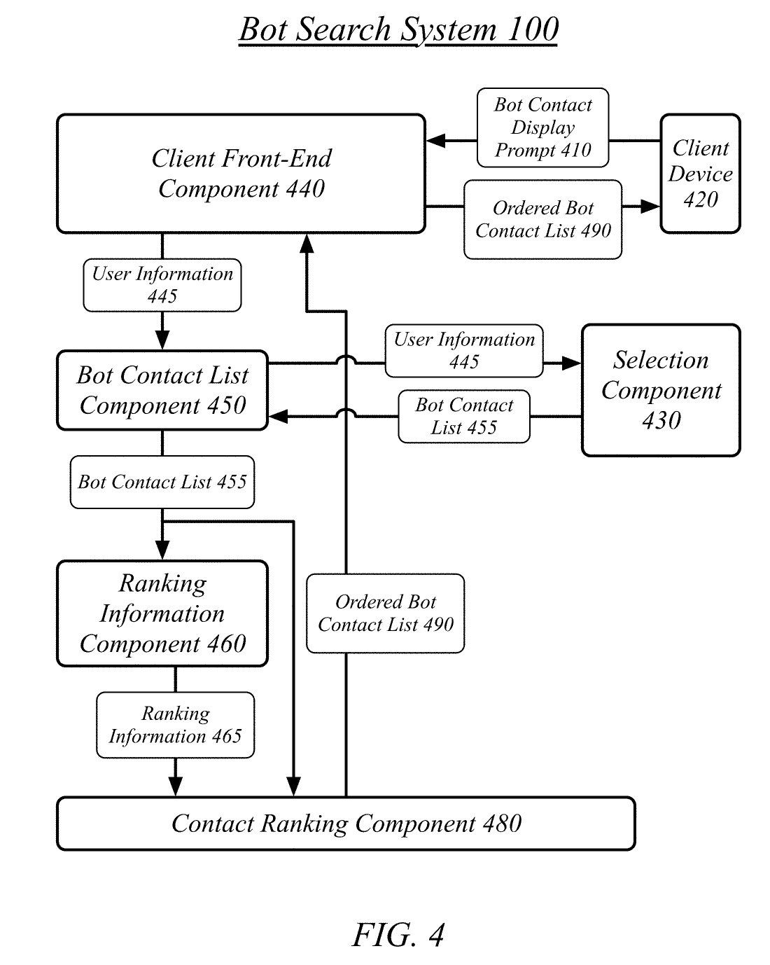

FIG. 4 illustrates an embodiment of a bot search system 100 performing a bot search.

The bot search system 100 may comprise a plurality of components. The bot search system 100 may be operative to provide an ordered bot contact list 490 to a client device 420. The ordered bot contact list 490 may configure the client device 420 for display of the bot contacts according to ranking weights.

The bot search system 100 may comprise a client front-end component 440. The client front-end component 440 may execute on a server device, and may be a component of a messaging server. The client front-end component 440 is generally arranged to exchange information with client devices to empower the client devices to engage in messaging activity using a messaging system. The client front-end component 440 provides access to various messaging services and/or social networking services. The client front-end component 440 provides an ordered bot contact list 490 to a client device 420. The retrieval of an ordered bot contact list 490 may be performed in association with a display of a search interface on the client device 420. The ordered bot contact list 490 may be generated and displayed independent of any search information or may be generated based on search information and displayed in response to the entry of the search information.

The client front-end component 440 receives a bot contact display prompt 410 for a user account from a client device 420. The user account may be an account registered with a messaging system. A bot contact display prompt 410 may be a display of a null-state search box, the reception of search information for a user, or any other opportunity to display bot contacts.

The bot search system 100 may comprise a bot contact list component 450. The bot contact list component 450 may execute on a server device, and may be a component of a messaging server. The bot contact list component 450 is generally arranged to retrieve and manage bot contacts. The bot contact list component 450 is operative to determine a bot contact list 455 for the user account. The bot contact list component 450 receives user information 445 from the client front-end component 440 identifying the user account for a client device 420. For instance, the user information 445 may comprise a user identifier uniquely identifying the user account within the bot search system 100.

The bot search system 100 may comprise a ranking information component 460. The ranking information component 460 may execute on a server device, and may be a component of a messaging server. The ranking information component 460 is generally arranged to determine ranking information 465 for a user in relation to bots based on user information for users of the bot search system 100. The user information may comprise social-networking information for a social networking service, such as may derived from a social graph 200. The ranking information component 460 generates ranking information 465 for the user and provides the ranking information 465 to the contact ranking component 480.

The bot search system 100 may comprise a contact ranking component 480. The contact ranking component 480 may execute on a server device, and may be a component of a messaging server. A contact ranking component 480 determines a ranking weight for each bot on the bot contact list 455 based on the ranking information 465. The contact ranking component 480 orders the bot contact list 455 for display for the user account based on the determined ranking weight for each bot on the bot contact list 455 to generate the ordered bot contact list 490.

The client front-end component 440 receives a bot contact display prompt from a client device. A bot contact display prompt is any indication from a client device 420 that there is an opportunity to display an ordered bot contact list 490 on the client device 420. In some instances, the bot contact display prompt 410 may comprise a null-state search prompt, wherein a search interface is shown without any search information having been entered, such as prior to the entry of search information. In some instances, the bot contact display prompt 410 may comprise a user search prompt, wherein search information is provided as part of the bot contact display prompt 410, with that search information used as at least a portion of generating the ordered bot contact list 490. Other instances may prompt a bot contact display prompt 410. For instance, bots may be promoted in various interfaces, such as an inbox view, with the display of an interface in which bots will be promoted prompting the bot contact display prompt 410.

The bot contact list component 450 receives user information 445 from the client front-end component 440 identifying a user for whom an ordered bot contact list 490 should be produced. The bot contact list component 450 retrieves a bot contact list 455 from a selection component. The bot contact list 455 comprising a plurality of bot contacts. The selection component 430 may comprise a component generally arranged to determine contacts for promotion to a user. In some cases, the selection component 430 may be provided with search information to aid in the selection of the bot contacts for the bot contact list 455. In some cases, the selection component 430 may be provided only the user information 445, such as when no search information is available.

In some embodiments, the selection component 430 may be arranged to generally promote business entities in a messaging system, with the selection of bots being a supported feature, but not the only support feature. In these embodiments, the selection component 430 may be generally arranged to retrieve business entities for promotion whether or not those business entities have bots associated with them, as, in some embodiments, only some business entities may have associated bots. In these embodiments, retrieving the bot contact list 455 from the selection component 430 may comprise configuring the selection component 430 for bot retrieval. Configuring the selection component 430 for bot retrieval may comprise identifying a bot contact list request as originating from a messaging client that is oriented towards messaging interactions, which therefore will benefit more from business contacts with associated bots than business contacts without associated bots. Configuring the selection component 430 for bot retrieval may comprise indicating to the selection component 430 that its generation of the bot contact list 455 should apply additional weight to those business entities with associated bots so as to increase the number of business contacts provided to the bot contact list component 450 that are associated with a bot.

The bot contact list component 450 passes the bot contact list 455 to the ranking information component 460 and the contact ranking component 480. The ranking information component 460 retrieves ranking information 465 for each of the bot contacts on the bot contact list 455 and provides the ranking information 465 to the contact ranking component 480. The contact ranking component 480 then determines a ranking weight for each of the plurality of bot contacts on the bot contact list 455. The contact ranking component 480 then generates an ordered bot contact list 490 by ordering the bot contact list 455 based on the ranking weight for each bot contact on the bot contact list 455.

The contact ranking component 480 provides the ordered bot contact list 490 to the client front-end component 440, which then sends the ordered bot contact list 490 to the client device 420 for display to the user. In some cases, the ordered bot contact list 490 is generated for a bot-specific display section. A bot-specific display section displays only bots so as to specifically promote bot results. In some cases, the ordered bot contact list is generated for a mixed-category top-results section. In these cases, the bot contacts are intermingled with non-bot contacts, such as user contacts, existing threads, existing groups, and/or any other contact for the messaging system. The bot contacts on the ordered bot contact list 490 may be intermingled with non-bot contacts according to ranking weights generated for bot contacts and non-bot contacts, so as to show a mix of results to the user. This technique may be used, for example, where it is unknown whether or not a user is searching for a bot. In some cases, the ordered bot contact list 490 is generated for two or more bot-category type sections. The bots on the ordered bot contact list 490 may be divided into categories and displayed, in order according to ranking weight, divided between these two-or-more bot-categories-type sections. Bot-category-type sections may include, without limitation, a games section, a transportation section, a food and drink section, a shopping section, a nearby-business section, or any other type of section.

In some embodiments, at least some portion of the generation and ordering of the ordered bot contact list 490 may be performed locally on the client device 420. For instance, the contact ranking component 480 may execute on the client device 420. The bot contact list component 450 may provide an unordered bot contact list 455 to the client device 420 via the client front-end component 440, with the client device 420 then ordering the bot contact list 455 to generate the ordered bot contact list 490 based on the ranking information 465. In these embodiments, the ranking information 465 may be stored locally on the client device 420. The messaging client on the client device 420 may further comprise the ranking information component 460, which accesses a local data store of ranking information 465 to provide to the contact ranking component 480. Alternatively, at least a portion of the ranking information 465 may be provided by a server-based ranking information component 460 via the client front-end component 440. In some embodiments, bot-specific ranking information and social-networking information may be provided to the client device 420 as ranking information 465, with the client device 420 generating geolocation information as additional ranking information, which is used by the client device 420 to generate and provide location-based bot search results using location-based bot ranking.

The messaging client on the client device 420 may provide a directory interface to empower users to browse available messaging experiences with bots. The directory interface may be accessed using a directory-access control. The directory interface may comprise a directory tab of a tabbed messaging interface, with a directory-access control comprising a directory tab control. The directory interface may comprise bots, social-networking pages, or both bot and social-networking pages. A business may be represented as a social-networking page, with the social-networking page identified with a social-networking page identifier uniquely identifying the business and its page with the social-networking system. The page may have a messaging identity, such that the page is enabled to be messaged with by users of a messaging system. Pages with a message identity may additionally have a messaging identifier associated with them, uniquely identifying the page as a message recipient with the messaging system. Pages may alternatively or additionally have one or more bot applications associated with them. Each bot application has a unique bot identifier identifying the bot. The bot identifier is associated with the page identifier to associate the bot with the page. In some embodiments, the bot identifier may also be used to identify the bot for messaging. In other embodiments, each bot may have a distinct bot identifier used to identify the bot for messaging. Pages may be included in a pages-specific category or may be mixed with bots. In some embodiments, pages may only be included if they exceed a minimum response rate threshold.

A directory interface may be initially displayed in a null-state configuration when a directory-access control is used to access the directory interface. A null-state configuration may comprise a plurality of panes, wherein each pane corresponds to a particular category categorized by the bot search system 100. Each pane may display a plurality of category-specific bots categorized in the category for that pane. The bots displayed in a particular pane may be a selected subset of all the bots categorized in the category for the pane. Additional bots in that category may be accessed through a displayed category-selection control, empowering access to an expanded view empowering browsing of all the bots in that category. In some cases, a category-selection control may be displayed in association with a pane of displayed bots. In other cases, a category-selection control may be displayed without bots of that category being displayed, such as in a displayed list of categories. A null-state configuration may include a recent-bot pane showing one or more bots recently used by a user or frequently used by a user. In some embodiments, the bot search system 100 may refrain from showing a bot category pane where the bot category has less than a predefined minimum number of bots categorized within it. A null-state configuration may comprise a display of promoted businesses that a user may message with. The null-state configuration may comprise a business promotion contact list ordered according to ranking weights generated based on predicted business messaging interest for each business contact on the business promotion contact list.

In some embodiments, a bot's category may be assigned by a bot developer for the bot. The bot developer may be empowered, or may be required, to select a primary category for the bot. The bot developer may also be empowered, or may also be required, to select a secondary category for the bot. Bot may also be divided based on geographic regions, such that bots are narrowed by the geographic region of a user and then categorized are used within that geographic region. A selection of bots may be provided in a particular pane based on various region or language. A region-based pane of bots may be presented. A language-based pane of bots may be presented. The ranking information 465 for a region-based pane of bots may include region-specific information. The ranking information 465 for a language-based pane of bots may include language-specific information. Ranking information 465 may be language or region specific by, for instance, using a language or region specific popularity measure, such that the popularity measure represents popularity with users using a particular language or in a particular region. Users receiving language or region specific panes may also be shown a global pane that uses global ranking information. In some embodiments, users may only be provided a global pane where insufficient information is available to generate a region or language specific pane.

A display of bots in a particular category may include a display of the most popular bots in that category. The most popular bots in a category, or the most popular bots in general, may be calculated using a popularity ranking formula. A ranking formula may be used that combines multiple measures to generate a ranking weight. The contact ranking component 480 may determine the ranking weight for each of a plurality of bot contacts on a bot contact list 455 based on a linear function of a bot growth measure, a bot responsiveness measure, a bot quality measure, and a bot volume measure. Each of the measures contributing to the linear function may be multiples by a predefined constant. The predefined constants may be determined based on machine learning techniques.

In one embodiment, a predefined growth constant multiplier for the bot growth measure may be larger than a predefined responsiveness constant multiplier for the bot responsiveness measure, while the predefined responsiveness constant multiplier is larger than a predefined quality constant multiplier for the bot quality measure, which predefined quality constant multiplier is larger than a predefined volume constant multiplier for the bot volume measure.

The bot growth measure may generally measure the recent growth rate of the bot. The bot growth measure may specifically comprise an amount of growth for the bot over a first time period plus an amount of growth over a second time period, wherein the second time period is longer than the first time period. The bot responsiveness measure may comprise an average responsiveness time for the bot plus a response rate for the bot. The bot quality measure may comprise a percentage of contacted users that engage with the bot within a predefined period of initial contact plus a retention rate for the bot over a second predefined period. The bot volume measure may comprise a number of interactions over the course of a day for the bot. Bots with a high block rate, a block rate higher than a predefined threshold, may be filtered out.

A nearby category may be provided to a user. The nearby category may include nearby businesses of multiple other categories. The nearby category may comprise bots with associated businesses that have locations near the client device 420, as determined based on geolocation techniques. The nearby category may include nearby businesses that are categorized in any of the shopping category, personal care category, food and drink category, and museum category. Bots from these categories may be examined to determine which correspond to businesses within a predefined range. Bots in the nearby category may be rotated periodically to provide different options to the user. Bots in the nearby category may be selected among that exceed a predefined minimum daily interaction rate threshold. The nearby category may, in some embodiments, only include bots that are specifically opted-in to being listed in the nearby category. Where nearby bots are promoted in a general bot promotion pane, non-local bots may also be promoted. In particular, bots to which the user has some affinity may be included, such as may be determined based on the user having liked a page for a business for the bot, the user having liked or interacted with a post on the page, or the user having visited a web site for the business.

A customer service category may be provided to a user. The customer service category may include bots associated with social-networking pages of particular types. The customer service category may draw from pages of the shopping type, business type, finance type, travel type, and home and auto type. Bots for the customer service category may be selected among those with a weekly conversation rate greater than a predefined threshold and a response rate above a predefined threshold. A customer service category may be presented that includes bots from each category or type of page, or a separate customer service category may be presented for each category or type of page.

Bot administrators may be offered the option to opt-out of directory listing. Where a bot sees a significant increase in volume, such as a percentage increase in volume greater than a predefined percentage, the bot administrator may be automatically offered the option opt-out of having their bot listed in a bot directory. Where a bot sees a more significant increase in volume, such as a percentage increase in volume greater than a larger predefined percentage, the bot may be automatically de-listed from the bot directory. Users may also be rate-limited in the number of messages they may send to a bot or social-networking page without having received a response from the bot within a predefined time period.

Various different ranking information 465 may be used in different circumstances. Where the bot contact display prompt comprising a null-state search prompt, the ranking information 465 may comprise bot-specific information and social-context information, such that determining the ranking weight for each of the plurality of bot contacts is based on bot-specific information and social-context information. Where the bot contact display prompt comprises a user search prompt, the ranking information 465 may comprise bot-specific information, social-context information, and additionally bot-specific search-result performance information, such that determining the ranking weight for each of the plurality of bot contacts is based on bot-specific information, social-context information, and bot-specific search-result performance information.

Bot-specific information comprises information gathered about the configuration and performance about a bot. Bot-specific information may comprise one or more of a page-bot relationship indicator, a bot category, a bot active-thread count, a bot user-retention rate, and a bot block rate. A page-bot relationship indicator indicates whether a returned business entity, as represented by a business page, has an associated bot. A page-bot relationship indicator is a positive indictor such that a business entity or business page with an associated bot is ranked higher than a business entity or business page without an associated bot, all else being equal. A bot category indicates a category into which a bot is organized. Bot category information may be used, without limitation, to introduce category variety into results, to match a bot category or search information, or for any other use. A bot active-thread count indicates a number of active threads that any user of the bot search system 100 has with a bot, where an active thread is one with activity (e.g., messaging activity) that is within a predefined period of recency. A bot active-thread count is a positive indicator, such that bots with a higher bot active-thread count are ranked higher, all else being equal. A bot user-retention rate indicates the historical trend for the bot of maintaining a relationship with a user given the initiation of a relationship with a user. A bot user-retention rate is another positive indicator, such that a bot with a higher bot user-retention rate is ranked higher than a bot with a lower bot user-retention rate, all else being equal. A bot block rate indicates a rate at which a bot is blocked from contacting a user by users of the bot search system 100. A bot block rate is a negative indicator, such that a bot with a higher bot block rate is ranked lower than a bot with a higher bot block rate, all else being equal.

Social-context information comprises information gathered about the relationship context between the bot and the user. The social-context information may comprising one or more of a bot-friend interaction count, a bot-history-similarity measure, a user-bot-block measure, and a messaging-context intent determination. The bot-friend interaction count indicates a count of a number of friends a user has that have interacted with that specific bot. Friends may be defined according to social-networking information from a social graph 200. The bot-friend interaction count is a positive indicator, such that a bot with a higher bot-friend interaction count is ranked higher than a bot with a lower bot-friend interaction count, all else being equal. The bot-history-similarity measure indicates a similarity between a bot and other bots that a user has interacted with in the past. Similarity may be based on a category of a bot, a type of service offered by a bot, or according to any other measure. The bot-history-similarity measure is a positive indicator, such that a bot with a higher bot-history-similarity measure is ranked higher than a bot with a lower bot-history-similarity measure, all else being equal. A user-bot-block measure indicates whether the specific user for which the ordered bot contact list 490 is being retrieved has specifically blocked a particular bot. A user-bot-block measure may be a hard-rejection measure, such that a bot that a user has previously blocked is never promoted to the user. A messaging-context intent determination is a determination from a messaging conversation of the relevance of a bot to the intent of the messaging context. The messaging-context intent determination is a positive indicator, such that a bot with a higher determined relevant intent is ranked higher than a bot with a lower determined relevant intent, all else being equal.

Bot-specific search-result performance information indicates the performance of a bot as a result of being presented in search results. Bot-specific search-result performance information may reflect the rate at which the bot is selected if offered as a part of search results, may reflect the rate at which an interaction with the bot is completed if the bot is selected from search results, may reflect user satisfaction with an interaction with the bot if the bot is selected from search results, may reflect any other measure related to a bot's performance as part of search results, and/or may reflect any combination of these measures.

The ranking weight for each of the plurality of bot contacts may be based on a rule-based model weighting the bot-specific information, the social-context information, and the bot-specific search-result performance information. The ranking weight for each of the plurality of bot contacts may specifically be based on a linear function combining the bot-specific information, the social-context information, and the bot-specific search-result performance information. This linear function may be determined based on a linear regression of a historical data set for bot interactions, the linear regression optimizing for one or more of bot click-through rate and top-used-bot summed-rankings.

Click-through rate corresponds to the rate at which a bot is clicked-through to if presented to a user, such as a result in a set of search results. Optimizing for click-through rate comprises optimization oriented towards a higher click-through rate.

Top-used-bot summed-rankings is a summation over the rankings of the top-used bots. The top-used bots are those bots that are most used in by users of a bot system. The top-used bots (e.g., the top one-hundred bots, the top one-thousand bots) each have their rank (where lower rank means a higher-profile presentation) summed together. Optimization for top-used-bot summed-rankings comprises optimization towards a lower top-used-bot summed-ranking, to reflect that the top-used bots are being correctly identified by the bot search system 100 and presented prominently, so as to put the bots that people seem to want to use in front of users.

Initially, the linear function may be manually configured. The bot search system 100 may then switch to the use of a historical data set once user interactions have been gathered. The use of heuristics with an early historical data set may be used to transition from a hand-tuned bot ranking to a model in which linear regression is used to tune parameters of a linear function and then ultimately to a full machine-learning system. The linear function may be trained on the historical data set to select and score highly those bots that match the optimization criteria.

In some embodiments, the contact ranking component 480 may modify the ranking weight for one or more of the plurality of bot contacts of the bot contact list 455 based on a compensated-promotion indicator for the one or more of the plurality of bot contacts. A compensated-promotion indicator indicates that a bot has been marked to be promoted in the search results based on compensation provided by an administrator of the bot. A static addition or multiplier may be contributed to the ranking weight for a bot with compensated promotion.

In some embodiments, the contact ranking component 480 may modify the ranking weight for one or more of the plurality of bot contacts based on an existing-bot-thread indicator for the one or more of the plurality of bot contacts. An existing-bot-thread indicator indicates that a user for whom the ordered bot contact list 490 is being prepared has an existing message thread with the bot. More generally, an existing-communication indicator may be used for contexts that aren't necessarily messaging, wherein an existing-communication indicator indicates that a user has communicated with the bot before. A static addition or multiplier may be contributed to the ranking weight for a bot with which the user has a previous messaging or communication relationship.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

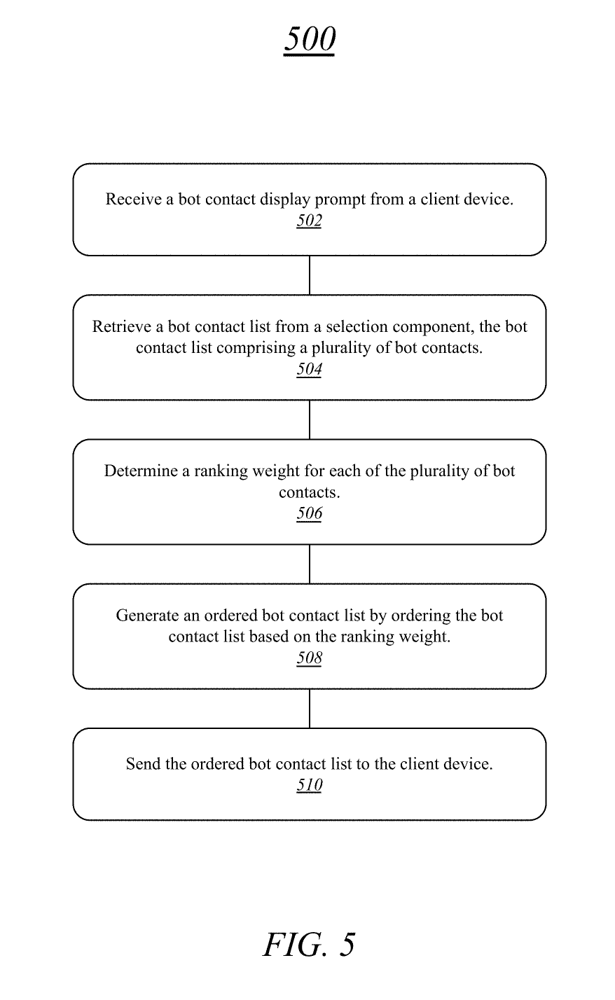

FIG. 5 illustrates one embodiment of a logic flow 500. The logic flow 500 may be representative of some or all of the operations executed by one or more embodiments described herein.

In the illustrated embodiment shown in FIG. 5, the logic flow 500 may receive a bot contact display prompt from a client device at block 502.

The logic flow 500 may retrieve a bot contact list from a selection component, the bot contact list comprising a plurality of bot contacts at block 504.

The logic flow 500 may determine a ranking weight for each of the plurality of bot contacts at block 506.

The logic flow 500 may generate an ordered bot contact list by ordering the bot contact list based on the ranking weight at block 508.

The logic flow 500 may send the ordered bot contact list to the client device at block 510.

The embodiments are not limited to this example.

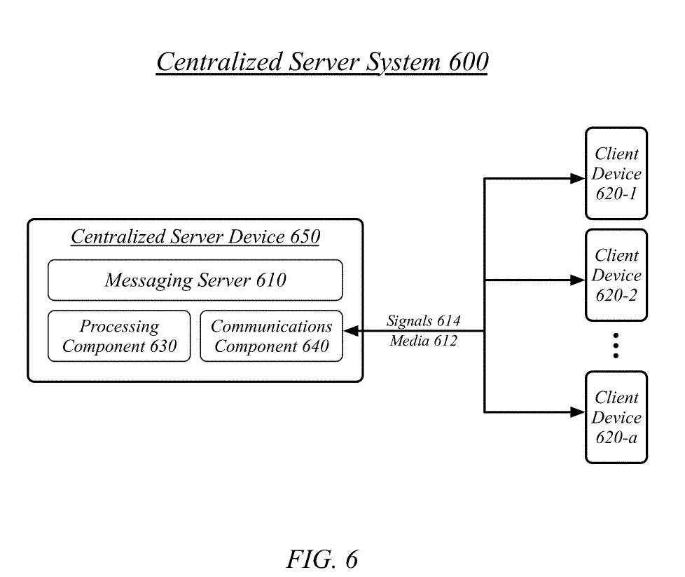

FIG. 6 illustrates a block diagram of a centralized system 600. The centralized system 600 may implement some or all of the structure and/or operations for the bot search system 100 in a single computing entity, such as entirely within a single centralized server device 650.

The centralized server device 650 may comprise any electronic device capable of receiving, processing, and sending information for the bot search system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The centralized server device 650 may execute processing operations or logic for the bot search system 100 using a processing component 630. The processing component 630 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The centralized server device 650 may execute communications operations or logic for the bot search system 100 using communications component 640. The communications component 640 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 640 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 612 includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The centralized server device 650 may communicate with other devices over a communications media 612 using communications signals 614 via the communications component 640. The devices may be internal or external to the centralized server device 650 as desired for a given implementation.

The centralized server device 650 may execute a messaging server 610. The messaging server 610 may comprise a messaging server for a messaging system, such as a messaging server performing messaging server functions as described for the messaging servers 110 in reference to FIG. 1. The centralized server device 650 may execute a plurality of components, including, without limitation, client front-end component 440, bot contact list component 450, ranking information component 460, and contact ranking component 480.

The messaging server 610 may provide messaging operations for a plurality of client devices 620, receiving and sending messages between the client devices 620. The client devices 620 may correspond to one or more of a smartphone device 150, tablet device 160, personal computer device 180, and/or any of the client device 305, client device 420, or any other client device.

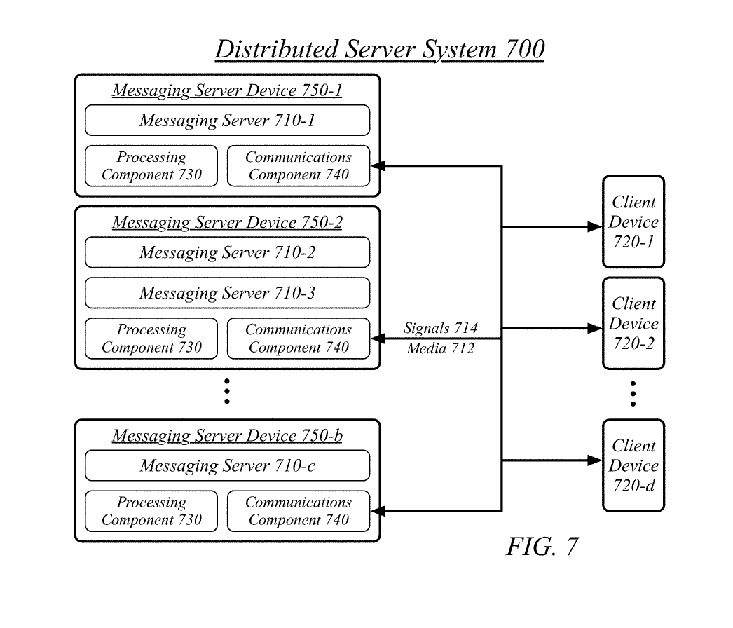

FIG. 7 illustrates a block diagram of a distributed system 700. The distributed system 700 may distribute portions of the structure and/or operations for the bot search system 100 across multiple computing entities. Examples of distributed system 700 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 700 may comprise a plurality of messaging server devices 750. In general, the server devices 750 may be the same or similar to the centralized server device 650 as described with reference to FIG. 6. For instance, the server devices 750 may each comprise a processing component 730 and a communications component 740 which are the same or similar to the processing component 630 and the communications component 640, respectively, as described with reference to FIG. 6. In another example, the server devices 750 may communicate over a communications media 712 using communications signals 714 via the communications components 740.

The messaging server devices 750 may comprise or employ one or more server programs that operate to perform various methodologies in accordance with the described embodiments. In one embodiment, for example, the messaging server devices 750 may each execute one of a plurality of messaging servers 710. The messaging servers 710 may comprise messaging servers for a messaging system, such as a messaging servers performing messaging server functions as described for the messaging servers 110 in reference to FIG. 1. The messaging server devices 750 may execute a plurality of components, including, without limitation, client front-end component 440, bot contact list component 450, ranking information component 460, and contact ranking component 480. The components may be distributed across the server devices of the distributed server system 700. In some embodiments, different server devices may execute different components. In other embodiments, some distributed server devices may execute multiple different components. Multiple instances of various components may be replicated across multiple server devices.

The messaging servers 710 may provide messaging operations for a plurality of client devices 720, receiving and sending messages between the client devices 720. The client devices 720 may correspond to one or more of a smartphone device 150, tablet device 160, personal computer device 180, and/or any of the client device 305, client device 420, client devices 620, or any other client device.

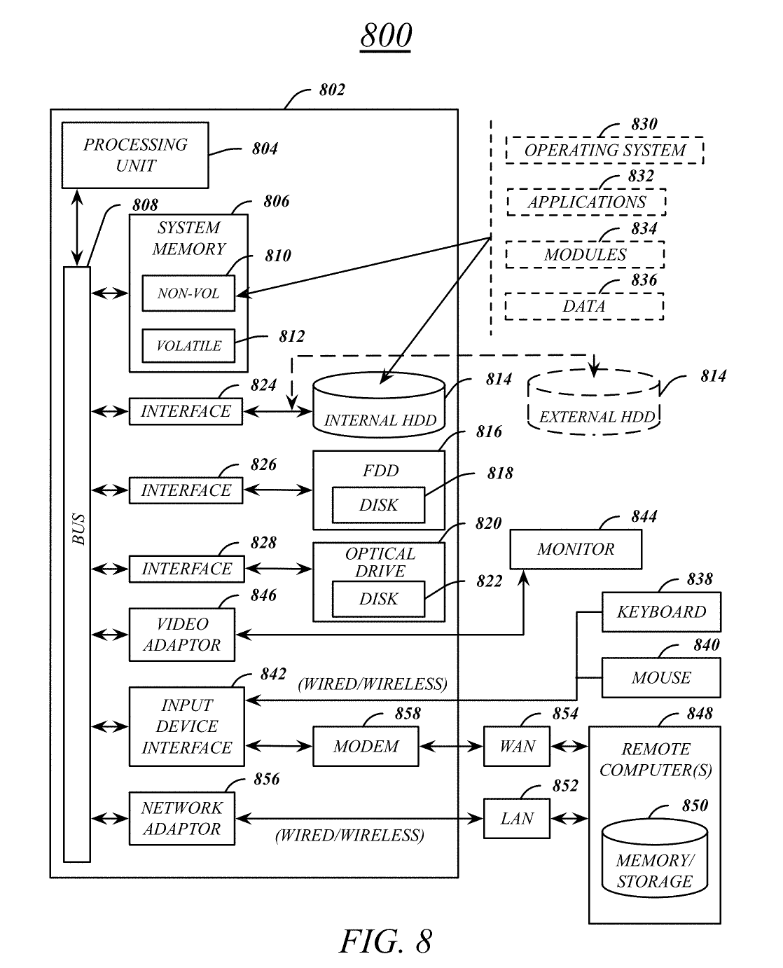

FIG. 8 illustrates an embodiment of an exemplary computing architecture 800 suitable for implementing various embodiments as previously described. In one embodiment, the computing architecture 800 may comprise or be implemented as part of an electronic device. Examples of an electronic device may include those described with reference to FIG. 8, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 804.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the bot search system 100.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

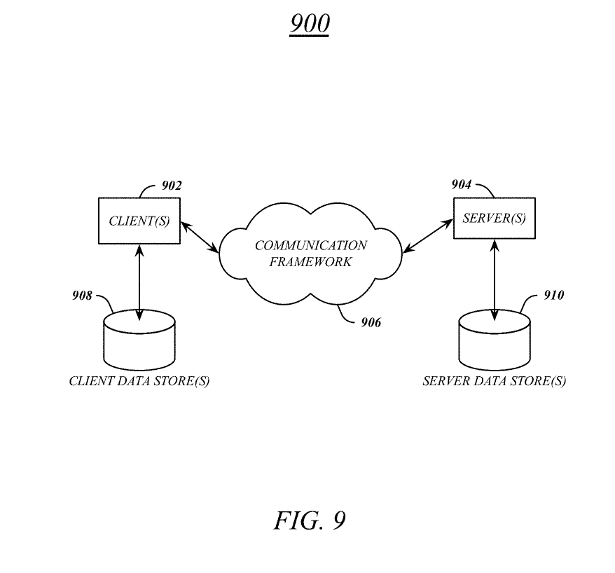

FIG. 9 illustrates a block diagram of an exemplary communications architecture 900 suitable for implementing various embodiments as previously described. The communications architecture 900 includes various common communications elements, such as a transmitter, receiver, transceiver, radio, network interface, baseband processor, antenna, amplifiers, filters, power supplies, and so forth. The embodiments, however, are not limited to implementation by the communications architecture 900.

As shown in FIG. 9, the communications architecture 900 comprises includes one or more clients 902 and servers 904. The clients 902 may implement messaging clients. The servers 904 may implement messaging servers 110. The clients 902 and the servers 904 are operatively connected to one or more respective client data stores 908 and server data stores 910 that can be employed to store information local to the respective clients 902 and servers 904, such as cookies and/or associated contextual information.

The clients 902 and the servers 904 may communicate information between each other using a communication framework 906. The communications framework 906 may implement any well-known communications techniques and protocols. The communications framework 906 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 906 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 902 and the servers 904. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

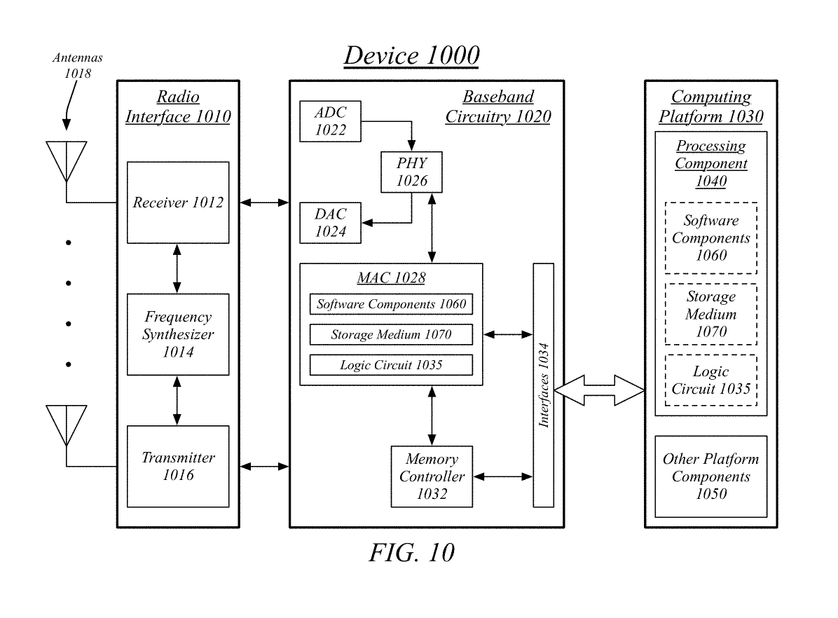

FIG. 10 illustrates an embodiment of a device 1000 for use in a multicarrier OFDM system, such as the bot search system 100. Device 1000 may implement, for example, software components 1060 as described with reference to bot search system 100 and/or a logic circuit 1035. The logic circuit 1035 may include physical circuits to perform operations described for the bot search system 100. As shown in FIG. 10, device 1000 may include a radio interface 1010, baseband circuitry 1020, and computing platform 1030, although embodiments are not limited to this configuration.

The device 1000 may implement some or all of the structure and/or operations for the bot search system 100 and/or logic circuit 1035 in a single computing entity, such as entirely within a single device. Alternatively, the device 1000 may distribute portions of the structure and/or operations for the bot search system 100 and/or logic circuit 1035 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 1010 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. Radio interface 1010 may include, for example, a receiver 1012, a transmitter 1016 and/or a frequency synthesizer 1014. Radio interface 1010 may include bias controls, a crystal oscillator and/or one or more antennas 1018. In another embodiment, radio interface 1010 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1020 may communicate with radio interface 1010 to process receive and/or transmit signals and may include, for example, an analog-to-digital converter 1022 for down converting received signals, a digital-to-analog converter 1024 for up converting signals for transmission. Further, baseband circuitry 1020 may include a baseband or physical layer (PHY) processing circuit 1056 for PHY link layer processing of respective receive/transmit signals. Baseband circuitry 1020 may include, for example, a processing circuit 1028 for medium access control (MAC)/data link layer processing. Baseband circuitry 1020 may include a memory controller 1032 for communicating with processing circuit 1028 and/or a computing platform 1030, for example, via one or more interfaces 1034.

In some embodiments, PHY processing circuit 1026 may include a frame construction and/or detection module, in combination with additional circuitry such as a buffer memory, to construct and/or deconstruct communication frames, such as radio frames. Alternatively or in addition, MAC processing circuit 1028 may share processing for certain of these functions or perform these processes independent of PHY processing circuit 1026. In some embodiments, MAC and PHY processing may be integrated into a single circuit.

The computing platform 1030 may provide computing functionality for the device 1000. As shown, the computing platform 1030 may include a processing component 1040. In addition to, or alternatively of, the baseband circuitry 1020, the device 1000 may execute processing operations or logic for the bot search system 100 and logic circuit 1035 using the processing component 1040. The processing component 1040 (and/or PHY 1026 and/or MAC 1028) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1030 may further include other platform components 1050. Other platform components 1050 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1000 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of device 1000 described herein, may be included or omitted in various embodiments of device 1000, as suitably desired. In some embodiments, device 1000 may be configured to be compatible with protocols and frequencies associated one or more of the 3GPP LTE Specifications and/or IEEE 1002.16 Standards for WMANs, and/or other broadband wireless networks, cited herein, although the embodiments are not limited in this respect.

Embodiments of device 1000 may be implemented using single input single output (SISO) architectures. However, certain implementations may include multiple antennas (e.g., antennas 1018) for transmission and/or reception using adaptive antenna techniques for beamforming or spatial division multiple access (SDMA) and/or using MIMO communication techniques.

The components and features of device 1000 may be implemented using any combination of discrete circuitry, application specific integrated circuits (ASICs), logic gates and/or single chip architectures. Further, the features of device 1000 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1000 shown in the block diagram of FIG. 10 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

A computer-implemented method may comprise receiving a bot contact display prompt from a client device; retrieving a bot contact list from a selection component, the bot contact list comprising a plurality of bot contacts; determining a ranking weight for each of the plurality of bot contacts; generating an ordered bot contact list by ordering the bot contact list based on the ranking weight; and sending the ordered bot contact list to the client device.

A computer-implemented method may further comprise wherein retrieving the bot contact list from the selection component comprises configuring the selection component for bot retrieval.

A computer-implemented method may further comprise the ordered bot contact list generated for one of a bot-specific display section, a mixed-category top-results section, and two or more bot-category type sections.

A computer-implemented method may further comprise the bot contact display prompt comprising a null-state search prompt, further comprising: determining the ranking weight for each of the plurality of bot contacts based on bot-specific information and social-context information.

A computer-implemented method may further comprise modifying the ranking weight for one or more of the plurality of bot contacts based on a compensated-promotion indicator for the one or more of the plurality of bot contacts.

A computer-implemented method may further comprise modifying the ranking weight for one or more of the plurality of bot contacts based on an existing-bot-thread indicator for the one or more of the plurality of bot contacts.

A computer-implemented method may further comprise the bot contact display prompt comprising a user search prompt, further comprising: determining the ranking weight for each of the plurality of bot contacts based on bot-specific information, social-context information, and bot-specific search-result performance information.

A computer-implemented method may further comprise the bot-specific information comprising one or more of a page-bot relationship indicator, a bot category, a bot active-thread count, a bot user-retention rate, and a bot block rate; the social-context information comprising one or more of a bot-friend interaction count, a bot-history-similarity measure, a user-bot-block measure, and a messaging-context intent determination.

A computer-implemented method may further comprise the ranking weight for each of the plurality of bot contacts based on a rule-based model weighting the bot-specific information, the social-context information, and the bot-specific search-result performance information.

A computer-implemented method may further comprise the ranking weight for each of the plurality of bot contacts based on a linear function combining the bot-specific information, the social-context information, and the bot-specific search-result performance information, the linear function determined based on a linear regression of a historical data set for bot interactions, the linear regression optimizing for one or more of bot click-through rate and top-used-bot summed-rankings.

A computer-implemented method may further comprise determining the ranking weight for each of the plurality of bot contacts based on a linear function of a bot growth measure, a bot responsiveness measure, a bot quality measure, and a bot volume measure.

An apparatus may comprise a client front-end component operative to receive a bot contact display prompt from a client device; and send an ordered bot contact list to the client device; a bot contact list component operative to retrieve a bot contact list from a selection component, the bot contact list comprising a plurality of bot contacts; and a contact ranking component operative to determine a ranking weight for each of the plurality of bot contacts; and generate the ordered bot contact list by ordering the bot contact list based on the ranking weight. In some embodiments, these components may be operative on a processor circuit on a device. The apparatus may be operative to implement any of the computer-implemented methods described herein.

At least one computer-readable storage medium may comprise instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method, comprising:
receiving a bot contact display prompt from a client device;
retrieving a bot contact list from a selection component, the bot contact list comprising a plurality of bot contacts;
determining a ranking weight for each of the plurality of bot contacts;
generating an ordered bot contact list by ordering the bot contact list based on the ranking weight; and
sending the ordered bot contact list to the client device.

2. The method of claim 1, the bot contact display prompt comprising a null-state search prompt, further comprising:
determining the ranking weight for each of the plurality of bot contacts based on bot-specific information and social-context information.

3. The method of claim 1, further comprising:
modifying the ranking weight for one or more of the plurality of bot contacts based on a compensated-promotion indicator for the one or more of the plurality of bot contacts.

4. The method of claim 1, further comprising:
modifying the ranking weight for one or more of the plurality of bot contacts based on an existing-bot-thread indicator for the one or more of the plurality of bot contacts.

5. The method of claim 1, the bot contact display prompt comprising a user search prompt, further comprising:
determining the ranking weight for each of the plurality of bot contacts based on bot-specific information, social-context information, and bot-specific search-result performance information.

6. The method of claim 5, the bot-specific information comprising one or more of a page-bot relationship indicator, a bot category, a bot active-thread count, a bot user-retention rate, and a bot block rate; the social-context information comprising one or more of a bot-friend interaction count, a bot-history-similarity measure, a user-bot-block measure, and a messaging-context intent determination.

7. The method of claim 5, the ranking weight for each of the plurality of bot contacts based on a linear function combining the bot-specific information, the social-context information, and the bot-specific search-result performance information, the linear function determined based on a linear regression of a historical data set for bot interactions, the linear regression optimizing for one or more of bot click-through rate and top-used-bot summed-rankings.

8. The method of claim 1, further comprising:
determining the ranking weight for each of the plurality of bot contacts based on a linear function of a bot growth measure, a bot responsiveness measure, a bot quality measure, and a bot volume measure.

9. An apparatus, comprising:
a client front-end component operative to receive a bot contact display prompt from a client device; and send an ordered bot contact list to the client device;
a bot contact list component operative to retrieve a bot contact list from a selection component, the bot contact list comprising a plurality of bot contacts; and
a contact ranking component operative to determine a ranking weight for each of the plurality of bot contacts; and generate the ordered bot contact list by ordering the bot contact list based on the ranking weight.

10. The apparatus of claim 9, further comprising:
the contact ranking weight operative to determine the ranking weight for each of the plurality of bot contacts based on a linear function of a bot growth measure, a bot responsiveness measure, a bot quality measure, and a bot volume measure.

11. The apparatus of claim 9, the bot contact display prompt comprising a user search prompt, further comprising:
the contact ranking component operative to determine the ranking weight for each of the plurality of bot contacts based on bot-specific information, social-context information, and bot-specific search-result performance information.

12. The apparatus of claim 11, the bot-specific information comprising one or more of a page-bot relationship indicator, a bot category, a bot active-thread count, a bot user-retention rate, and a bot block rate; the social-context information comprising one or more of a bot-friend interaction count, a bot-history-similarity measure, a user-bot-block measure, and a messaging-context intent determination.

13. The apparatus of claim 11, the ranking weight for each of the plurality of bot contacts based on a linear function combining the bot-specific information, the social-context information, and the bot-specific search-result performance information, the linear function determined based on a linear regression of a historical data set for bot interactions, the linear regression optimizing for one or more of bot click-through rate and top-used-bot summed-rankings.

14. At least one computer-readable storage medium comprising instructions that, when executed, cause a system to:
receive a bot contact display prompt from a client device;
retrieve a bot contact list from a selection component, the bot contact list comprising a plurality of bot contacts;
determine a ranking weight for each of the plurality of bot contacts;
generate an ordered bot contact list by ordering the bot contact list based on the ranking weight; and
send the ordered bot contact list to the client device.

15. The computer-readable storage medium of claim 14, comprising further instructions that, when executed, cause a system to:
determine the ranking weight for each of the plurality of bot contacts based on a linear function of a bot growth measure, a bot responsiveness measure, a bot quality measure, and a bot volume measure.

16. The computer-readable storage medium of claim 14, comprising further instructions that, when executed, cause a system to:
modify the ranking weight for one or more of the plurality of bot contacts based on a compensated-promotion indicator for the one or more of the plurality of bot contacts.

17. The computer-readable storage medium of claim 14, comprising further instructions that, when executed, cause a system to:
modify the ranking weight for one or more of the plurality of bot contacts based on an existing-bot-thread indicator for the one or more of the plurality of bot contacts.

18. The computer-readable storage medium of claim 14, the bot contact display prompt comprising a user search prompt, comprising further instructions that, when executed, cause a system to:
determine the ranking weight for each of the plurality of bot contacts based on bot-specific information, social-context information, and bot-specific search-result performance information.

19. The computer-readable storage medium of claim 18, the bot-specific information comprising one or more of a page-bot relationship indicator, a bot category, a bot active-thread count, a bot user-retention rate, and a bot block rate; the social-context information comprising one or more of a bot-friend interaction count, a bot-history-similarity measure, a user-bot-block measure, and a messaging-context intent determination.

20. The computer-readable storage medium of claim 18, the ranking weight for each of the plurality of bot contacts based on a linear function combining the bot-specific information, the social-context information, and the bot-specific search-result performance information, the linear function determined based on a linear regression of a historical data set for bot interactions, the linear regression optimizing for one or more of bot click-through rate and top-used-bot summed-rankings.
